(19) United States
(12) Patent Application Publication
(10) Pub. No.: US 2017/0187321 A1
(43) Pub. Date: Jun. 29, 2017

(54) MOTOR CONTROL DEVICE, MOTOR CONTROL SYSTEM, IMAGE FORMING APPARATUS, CONVEYANCE APPARATUS, AND MOTOR CONTROL METHOD

(71) Applicants: Shingo NAGATSUKA, Kanagawa (JP); Kentaroh KUROSU, Kanagawa (JP); Yoshihiro ASANO, Kanagawa (JP); Motoharu TAKAHASHI, Kanagawa (JP); Takuya MURATA, Tokyo (JP)

(72) Inventors: Shingo NAGATSUKA, Kanagawa (JP); Kentaroh KUROSU, Kanagawa (JP); Yoshihiro ASANO, Kanagawa (JP); Motoharu TAKAHASHI, Kanagawa (JP); Takuya MURATA, Tokyo (JP)

(73) Assignee: Ricoh Company, Ltd., Tokyo (JP)

(21) Appl. No.: 15/387,821

(22) Filed: Dec. 22, 2016

(30) Foreign Application Priority Data
Dec. 28, 2015 (JP) 2015-256757
Jan. 27, 2016 (JP) 2016-013817

(51) Int. Cl. H02P 31/00; G03G 15/00; H02P 3/04

(52) U.S. Cl. CPC H02P 31/00; H02P 3/04; G03G 15/6529

(57) ABSTRACT

A motor control device includes a controller and a detector. The controller is configured to control, when receiving an operation request indicating rotation or stop of a motor, rotation of the motor based on the operation request. The detector is configured to detect whether the motor is rotating. The controller stops the motor when the detector detects rotation of the motor after an elapsed time from reception of the operation request indicating stop of the motor reaches a first threshold.

### CROSS-REFERENCE TO RELATED APPLICATIONS

The present application claims priority under 35 U.S.C. §119 to Japanese Patent Application No. 2015-256757, filed Dec. 28, 2015 and Japanese Patent Application No. 2016-013817, filed Jan. 27, 2016. The contents of which are incorporated herein by reference in their entirety.

### BACKGROUND OF THE INVENTION

1. Field of the Invention

The present invention relates to a motor control device, a motor control system, an image forming apparatus, a conveyance apparatus, and a motor control method.

2. Description of the Related Art

A motor control device such as a motor drive integrated circuit controlling a motor includes a plurality of terminals such as a speed control terminal to which a speed control signal indicating the rotation speed of a motor is input, a power-off terminal to which an off signal indicating power-off of a motor is input, and start/stop terminals to which a drive control signal indicating rotation or stop of a motor is input in order to meet a wide variety of requests. However, if a plurality of terminals are provided to a motor control device of one chip, an increase in the number of terminals causes an increase in circuit scale.

There is a method for reducing the number of terminals without causing deterioration in functions of a motor control device by deleting, out of a plurality of terminals included in the motor control device, a part of the terminals and using other terminals for supplementing the same functions as those of the deleted terminals. For example, in a motor control device where a power-off terminal is deleted, a speed control signal input from a speed control terminal indicates stop of a motor, and, when a signal indicating a change of a frequency depending on the rotation speed of the motor is not detected, a power supply to the motor control device is shut off and the motor stops so as to supplement functions of the power-off terminal.

However, in the motor control device where a power-off terminal is deleted, if a harness connected to a speed control terminal is grounded, short-circuited, and the like, a speed control signal is not input. The motor control device cannot detect indication for stopping a motor by the speed control signal, and malfunction of the motor occurs. In this case, when the motor is pulse width modulation (PWM)-controlled, a duty ratio during drive of the motor becomes maximum, and the motor may rotate at a maximum speed. There is a technique of stopping rotation due to malfunction of a motor when stop of the motor is indicated by using two isolation circuits that are a driving circuit for rotating the motor and a braking circuit insulated and separated from the driving circuit for stopping the motor, but adding the isolation circuits causes an increase in circuit scale.

### SUMMARY OF THE INVENTION

According to one aspect of the present invention, a motor control device includes a controller and a detector. The controller is configured to control, when receiving an operation request indicating rotation or stop of a motor, rotation of the motor based on the operation request. The detector is configured to detect whether the motor is rotating. The controller stops the motor when the detector detects rotation of the motor after an elapsed time from reception of the operation request indicating stop of the motor reaches a first threshold.

### BRIEF DESCRIPTION OF THE DRAWINGS

FIG. 1 is a view illustrating an example of a whole configuration of an image forming apparatus in accordance with an embodiment of the present invention;

FIG. 2 is a block diagram illustrating an example of the configuration of a motor drive apparatus and a host apparatus included in the image forming apparatus in accordance with the embodiment;

FIG. 3 is a block diagram illustrating an example of a functional configuration of the motor drive apparatus and the host apparatus included in the image forming apparatus in accordance with the embodiment;

FIG. 4 is a view illustrating an example of processing for controlling a motor in the image forming apparatus in accordance with the embodiment when an abnormality occurs after stop of the motor;

FIG. 5 is a view illustrating an example of processing for controlling the motor in the image forming apparatus in accordance with the embodiment when an abnormality occurs during rotation of the motor; and

FIG. 6 is a flowchart illustrating an example of a flow of processing for controlling a motor executed by a motor control device in the image forming apparatus in accordance with the embodiment.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

An object of an embodiment is to prevent malfunction of a motor in a state in which stop of the motor is indicated and prevent an increase in circuit scale.

### First Embodiment

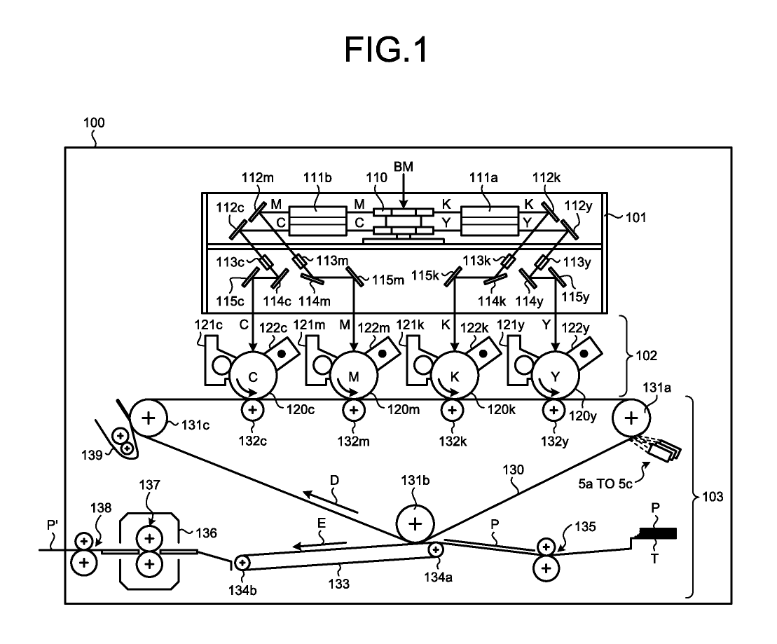

FIG. 1 is a view illustrating an example of a whole configuration of an image forming apparatus in accordance with the embodiment. As illustrated in FIG. 1, an image forming apparatus 100 (an example of an image processor) in accordance with the embodiment is an electrophotographic image forming apparatus that includes a secondary transfer mechanism known as a tandem system. The image forming apparatus 100 is an image forming apparatus included in a multifunction peripheral.

The image forming apparatus 100 roughly includes an optical apparatus 101, an imaging apparatus 102, and a transfer apparatus 103. The optical apparatus 101 deflects beams BM emitted from a light source such as a plurality of lasers with a polygon mirror 110, and the beams BM enter scanning lenses 111a and 111b. Examples of the scanning lenses 111a and 111b include fθ lenses. A light beam BM for forming an image of black (K) (hereinafter, referred to as a light beam BMK) and a light beam BM for forming an image of yellow (Y) (hereinafter, referred to as a light beam BMY) enter the scanning lens 111a. A light beam BM for forming an image of magenta (M) (hereinafter, referred to as a light beam BMM) and a light beam BM for forming an image of cyan (C) (hereinafter, referred to as a light beam BMC) enter the scanning lens 111b.

The light beam BMK passes through the scanning lens 111a, and is reflected by a mirror 112k. The light beam BMY passes through the scanning lens 111a, and is reflected by a mirror 112y. The light beam BMM passes through the scanning lens 111b, and is reflected by a mirror 112m. The light beam BMC passes through the scanning lens 111b, and is reflected by a mirror 112c.

A WTL lens 113k shapes the light beam BMK reflected by the mirror 112k, and the light beam BMK enters a reflection mirror 114k. A WTL lens 113y shapes the light beam BMY reflected by the mirror 112y, and the light beam BMY enters a reflection mirror 114y. A WTL lens 113m shapes the light beam BMM reflected by the mirror 112m, and the light beam BMM enters a reflection mirror 114m. A WTL lens 113c shapes the light beam BMC reflected by the mirror 112c, and the light beam BMC enters a reflection mirror 114c.

The reflection mirror 114k deflects the light beam BMK entered from the WTL lens 113k, and the light beam BMK enters a reflection mirror 115k. The reflection mirror 114y deflects the light beam BMY entered from the WTL lens 113y, and the light beam BMY enters a reflection mirror 115y. The reflection mirror 114m deflects the light beam BMM entered from the WTL lens 113m, and the light beam BMM enters a reflection mirror 115m. The reflection mirror 114c deflects the light beam BMC entered from the WTL lens 113c, and the light beam BMC enters a reflection mirror 115c.

The reflection mirror 115k reflects the light beam BMK entered from the reflection mirror 114k, and irradiates a photoconductor 120k with the light beam BMK. The reflection mirror 115y reflects the light beam BMY entered from the reflection mirror 114y, and irradiates a photoconductor 120y with the light beam BMY. The reflection mirror 115m reflects the light beam BMM entered from the reflection mirror 114m, and irradiates a photoconductor 120m with the light beam BMM. The reflection mirror 115c reflects the light beam BMC entered from the reflection mirror 114c, and irradiates a photoconductor 120c with the light beam BMC.

In this manner, a plurality of optical elements such as the WTL lenses 113k, 113y, 113m, and 113c, the reflection mirrors 114k, 114y, 114m, and 114c, and the reflection mirrors 115k, 115y, 115m, and 115c are used for irradiating the photoconductors 120k, 120y, 120m, and 120c with the light beams BMK, BMY, BMM, and BMC, respectively. Hereinafter, a scanning direction of the light beams BM to the photoconductors 120k, 120y, 120m, and 120c is a main-scanning direction. By contrast, a rotating direction of the photoconductors 120k, 120y, 120m, and 120c is a sub-scanning direction.

Each of the photoconductors 120k, 120y, 120m, and 120c includes at least a charge occurrence layer, a charge transport layer, and a photoconductive layer on a conductive drum such as aluminum. Chargers 122k, 122y, 122m, and 122c apply electric charge to the photoconductors 120k, 120y, 120m, and 120c, respectively. The photoconductors 120k, 120y, 120m, and 120c to which the chargers 122k, 122y, 122m, and 122c apply electric charge are exposed to the light beams BMK, BMY, BMM, and BMC, respectively. In this manner, electrostatic latent images are formed on the surfaces (hereinafter, referred to as scanned surfaces) of the photoconductors 120k, 120y, 120m, and 120c exposed to the light beams BMK, BMY, BMM, and BMC.

Developing devices 121k, 121y, 121m, and 121c each include a developing sleeve, a developer supply roller, a control blade, and the like. Electrostatic latent images formed on the scanned surfaces of the photoconductors 120k, 120y, 120m, and 120c are developed by the developing devices 121k, 121y, 121m, and 121c, respectively. In this manner, developer images are formed on the scanned surfaces of the photoconductors 120k, 120y, 120m, and 120c.

Developer images formed on the scanned surfaces of the photoconductors 120k, 120y, 120m, and 120c are transferred by primary transfer rollers 132k, 132y, 132m, and 132c, respectively, on an intermediate transfer belt 130 that is moved in a direction of an arrow D by conveyance rollers 131a to 131c. The intermediate transfer belt 130 (intermediate transfer body) on which developer images are being transferred from the photoconductors 120k, 120y, 120m, and 120c is conveyed to a secondary transfer unit.

The secondary transfer unit includes a secondary transfer belt 133, a conveyance roller 134a, and a conveyance roller 134b. The secondary transfer belt 133 is conveyed in a direction of an arrow E by the conveyance roller 134a and the conveyance roller 134b.

The secondary transfer unit supplies a recording medium P from a recording medium housing unit T such as a paper feeding cassette using a conveyance roller 135. Examples of the recording medium P that is an image receiving material include paper, a plastic sheet, and a metal sheet. The secondary transfer unit applies a secondary transfer bias voltage to the recording medium P, and transfers the developer images formed on the intermediate transfer belt 130 to the recording medium P attracted and held on the secondary transfer belt 133. Subsequently, the recording medium P is conveyed to a fixing apparatus 136 by the secondary transfer belt 133.

The fixing apparatus 136 includes a fixing member 137 such as a fixing roller. The fixing member 137 is a member such as silicone rubber and fluorine-contained rubber. The fixing apparatus 136 pressurizes and heats the developer images transferred to the recording medium P, and fixes the developer images on the recording medium P. A paper ejection roller 138 ejects the recording medium P on which the developer images are fixed as a “printed material P′” to the outside of the image forming apparatus 100.

After the developer images are transferred to the recording medium P, a cleaning unit 139 removes the remaining developer from the intermediate transfer belt 130. Subsequently, the image forming apparatus 100 shifts to a next image forming process.

Detection sensors 5a to 5c detect a test pattern formed on the intermediate transfer belt 130. Examples of the test pattern include a test pattern for correcting a color shift and a test pattern for correcting density. Examples of the detection sensors 5a to 5c include a reflective photosensor. The image forming apparatus 100 corrects various kinds of shift amounts such as color shift and density based on a result of a test pattern detected by the detection sensors 5a to 5c.

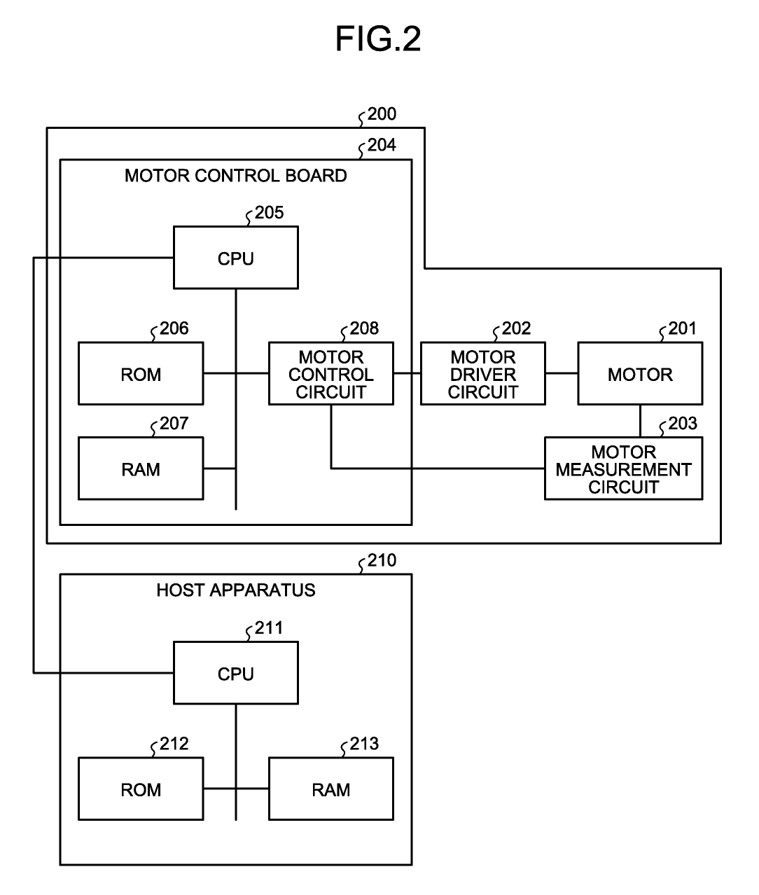

The following describes a motor drive apparatus (an example of a motor control system) that drives various kinds of conveyance mechanisms (for example, the conveyance rollers 131a to 131c, 132k, 132y, 132m, 132c, 134a, 134b, and 135) included in the image forming apparatus 100, and a host apparatus that controls the whole image forming apparatus 100 with reference to FIG. 2. FIG. 2 is a block diagram illustrating an example of the configuration of the motor drive apparatus and the host apparatus included in the image forming apparatus in accordance with the embodiment. In the embodiment, various kinds of conveyance mechanisms and the motor drive apparatus function as an example of the conveyance apparatus.

As illustrated in FIG. 2, a host apparatus 210 included in the image forming apparatus 100 in accordance with the embodiment includes a central processing unit (CPU) 211, a read only memory (ROM) 212, and a random access memory (RAM) 213. The CPU 211 executes processing for controlling the image forming apparatus 100 including processing for transmitting an operation request to a motor drive apparatus 200, which will be described later, on the basis of a computer program stored in the ROM 212, which will be described later. An operation request indicates rotation or stop of a motor 201, which will be described later. In the embodiment, when indicating rotation of the motor 201, an operation request includes a target rotation speed of the motor 201. The ROM 212 stores therein various kinds of computer programs related to processing for controlling the image forming apparatus 100. The RAM 213 is used as a working area when the CPU 211 executes the computer program.

As illustrated in FIG. 2, the motor drive apparatus 200 included in the image forming apparatus 100 in accordance with the embodiment includes the motor 201, a motor driver circuit 202, a motor measurement circuit 203, and a motor control board 204 (an example of a motor control apparatus). Examples of the motor 201 include a brushless motor and a brush motor, and the motor 201 is rotated and driven so as to drive various kinds of conveyance mechanisms. The motor 201 includes a brake for stopping rotation of the motor 201 (for example, a short brake). When stopping rotation of the motor 201, the short brake supplies current in a direction opposite to rotation of the motor 201 to armature winding, adds braking force to the motor 201, and stops rotation of the motor 201. In the embodiment, the motor drive apparatus 200 includes the plurality of motors 201. The motor driver circuit 202 rotates and drives the motors 201. The motor measurement circuit 203 detects the rotation speed of each of the motors 201. The motor control board 204 controls the motors 201 to be rotated and driven through the motor driver circuit 202.

As illustrated in FIG. 2, in the embodiment, the motor control board 204 includes a CPU 205, a ROM 206, a RAM 207, and a motor control circuit 208. The CPU 205 receives an operation request from external equipment such as the host apparatus 210 on the basis of a computer program stored in the ROM 206, which will be described later, and controls the whole motor drive apparatus 200. The ROM 206 stores therein various kinds of computer programs related to control of the whole motor drive apparatus 200. The RAM 207 is used as a working area when the CPU 205 executes a computer program.

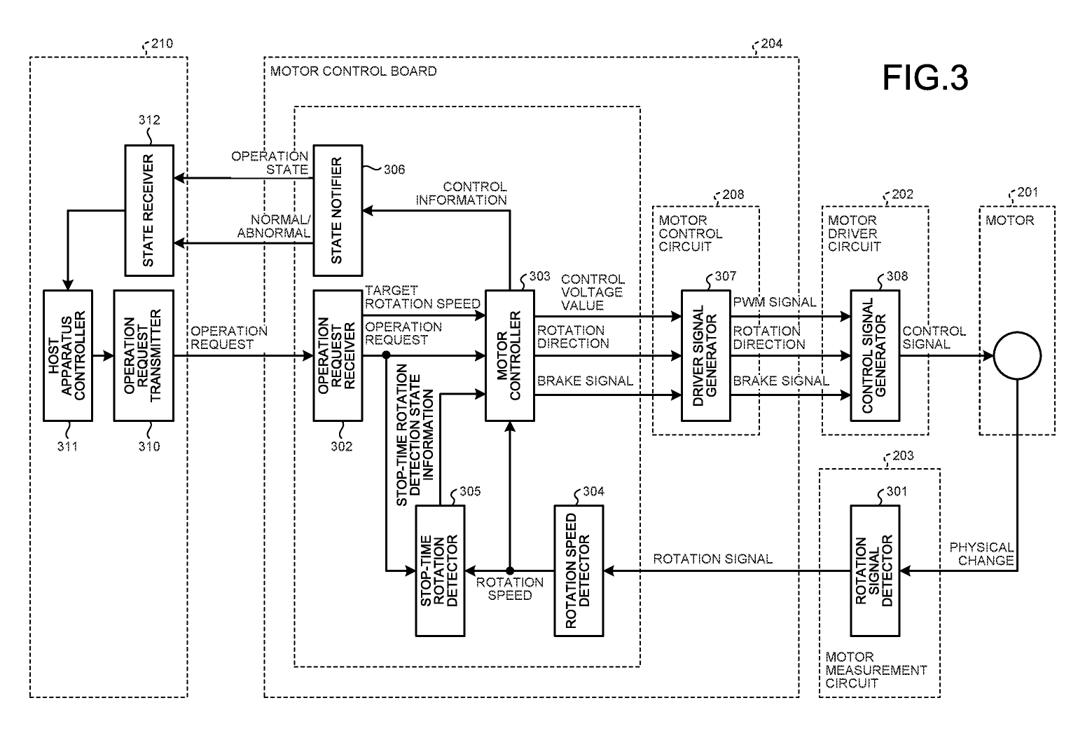

The following describes a functional configuration of the motor drive apparatus 200 and the host apparatus 210 included in the image forming apparatus 100 in accordance with the embodiment with reference to FIG. 3. FIG. 3 is a block diagram illustrating an example of a functional configuration of the motor drive apparatus and the host apparatus included in the image forming apparatus in accordance with the embodiment.

As illustrated in FIG. 3, in the embodiment, the CPU 211 uses the RAM 213 as a working area, and executes a computer program stored in the ROM 212 so as to implement an operation request transmitter 310, a host apparatus controller 311, and a state receiver 312. The host apparatus controller 311 (an example of a host controller) executes processing for controlling the image forming apparatus 100 including transmission of an operation request through the operation request transmitter 310, which will be described later. The operation request transmitter 310 receives an indication from the host apparatus controller 311, and transmits an operation request to the motor control board 204. The state receiver 312 receives an operation state of the motors 201 (for example, whether the motors 201 operate normally or abnormally) from the motor control board 204.

The motor measurement circuit 203 includes a rotation signal detector 301. The rotation signal detector 301 detects a physical change related to rotation of the motors 201 using an encoder, and fluxgate (FG) sensor, and the like. The rotation signal detector 301 transmits a rotation signal representing the detected physical change to a rotation speed detector 304, which will be described later.

As illustrated in FIG. 3, in the embodiment, the CPU 205 uses the RAM 207 as a working area, and executes a computer program stored in the ROM 206 so as to implement an operation request receiver 302, a motor controller 303, the rotation speed detector 304, a stop-time rotation detector 305, and a state notifier 306. The operation request receiver 302 (an example of a receiver) receives an operation request indicating rotation of the motors 201 and a target rotation speed of the motors 201 or stop of the motors 201 from an external apparatus such as the host apparatus 210 and a server. The operation request receiver 302 transmits the received operation request to the motor controller 303.

The rotation speed detector 304 receives a rotation signal from the rotation signal detector 301, and detects the rotation speed of the motors 201 on the basis of the received rotation signal. The rotation speed detector 304 transmits the rotation speed of the motors 201 to the motor controller 303 and the stop-time rotation detector 305.

The stop-time rotation detector 305 (an example of a detector) detects whether the motors 201 are rotating. In the embodiment, when the operation request receiver 302 receives an operation request indicating stop of the motors 201, the stop-time rotation detector 305 detects whether the motors 201 are rotating on the basis of the result of the rotation speed of the motors 201 detected by the rotation speed detector 304. The stop-time rotation detector 305 transmits stop-time rotation detection state information indicating the detection result of whether the motors 201 are rotating to the motor controller 303. In the stop-time rotation detection state information, the detection result of whether the motors 201 are rotating is represented in a binary value. Specifically, in the stop-time rotation detection state information, when rotation of the motors 201 is detected, the detection result is represented as “1”, and when stop of the motors 201 is detected, the detection result is represented as “0”.

When the operation request receiver 302 receives an operation request, the motor controller 303 (an example of a controller) controls rotation of the motors 201 on the basis of the operation request. In the embodiment, the motor controller 303 transmits a control voltage value, a rotation direction, and a brake signal to the motor control circuit 208 on the basis of the operation request received by the operation request receiver 302, the rotation speed of the motors 201 detected by the rotation speed detector 304, the result of whether the motors 201 are rotating (in the embodiment, the stop-time rotation detection state information) detected by the stop-time rotation detector 305, and the like so as to control the motors 201. In the embodiment, the control voltage value is a voltage applied to the motors 201. The rotation direction is a direction in which the motors 201 are rotated. The brake signal is a signal indicating whether rotation of the motors 201 is stopped. Specifically, when an operation request indicates rotation of the motors 201, the motor controller 303 (an example of the controller) adjusts the rotation speed of the motors 201 to a target rotation speed indicated by the operation request. By contrast, when an operation request indicates stop of the motors 201, the motor controller 303 stops the motors 201. In the embodiment, the motor controller 303 stops supplying power to a brake included in each of the motors 201 or the motors 201 so as to stop the motors 201. When an operation request received by the operation request receiver 302 indicates rotation of the motors 201, the motor controller 303 (an example of the detector) compares a target rotation speed indicated by the operation request with the rotation speed of the motors 201 detected by the rotation speed detector 304. When a difference between the target rotation speed and the detected rotation speed of the motors 201 is larger than a predetermined value, the motor controller 303 detects that there is an abnormality in rotation of the motors 201. When a state in which a difference between the target rotation speed and the detected rotation speed of the motors 201 is larger than a predetermined value is continued for a predetermined time, the motor controller 303 may detect an abnormality in rotation of the motors 201. The motor controller 303 transmits control information indicating a control result of the motors 201 (for example, the rotation speed of the motors 201, a result of whether the motors 201 are rotating detected by the stop-time rotation detector 305, a detection result of an abnormality in rotation of the motors 201 when an operation request indicates rotation of the motors 201, and the like) to the state notifier 306.

The state notifier 306 receives control information from the motor controller 303. The state notifier 306 notifies an external apparatus such as a server of an operation state of the motors 201 (for example, whether the motors 201 operate normally or abnormally) on the basis of the received control information.

The motor control circuit 208 includes a driver signal generator 307. The driver signal generator 307 receives a control voltage value, a rotation direction, and a brake signal from the motor controller 303. The driver signal generator 307 generates a pulse width modulation (PWM) signal on the basis of the received control voltage value. The driver signal generator 307 outputs a PWM signal, a rotation direction, and a brake signal to the motor driver circuit 202.

The motor driver circuit 202 includes a control signal generator 308. The control signal generator 308 generates a control signal for controlling the motors 201 on the basis of a PWM signal, a rotation direction, and a brake signal output from the driver signal generator 307. The control signal generator 308 outputs the generated control signal to the motors 201 so as to control the motors 201.

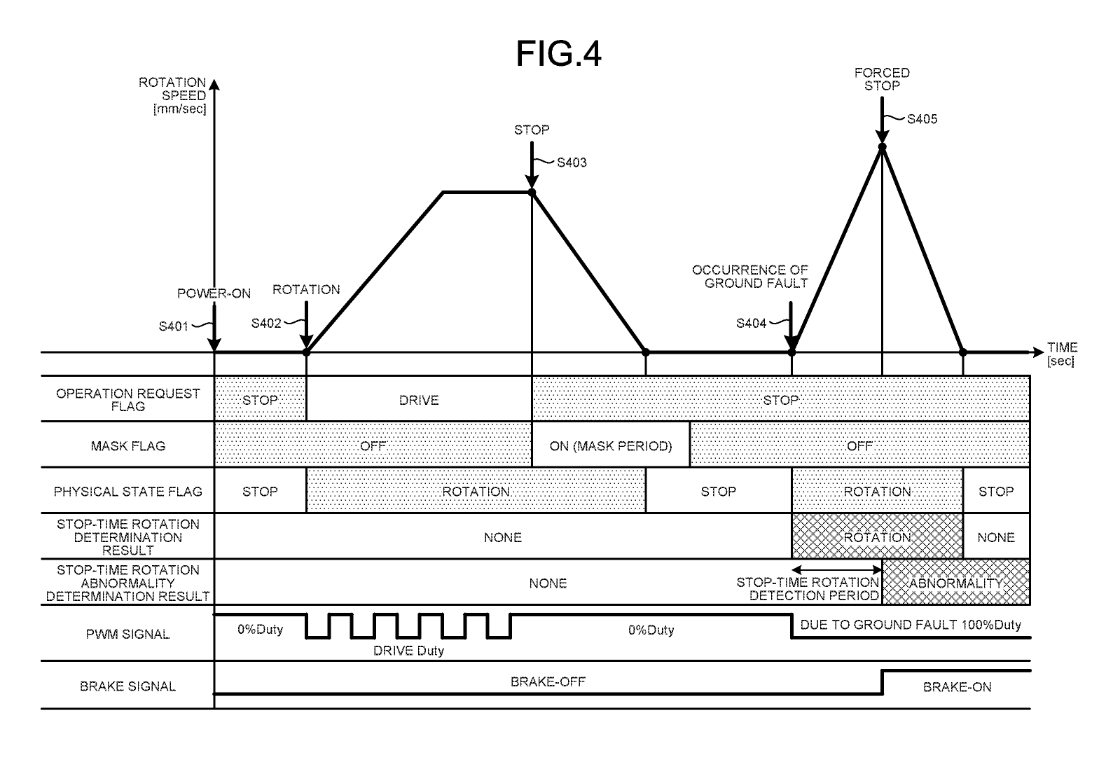

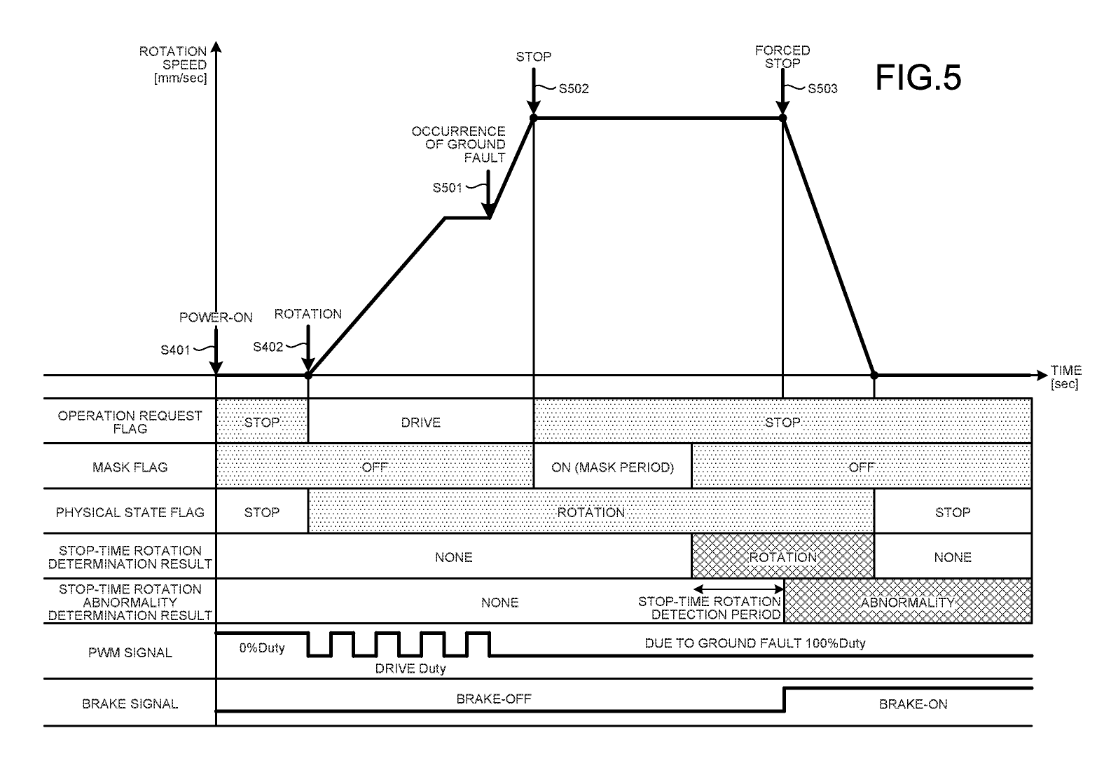

The following describes processing for controlling the motors 201 executed by a motor control device 20 included in the image forming apparatus 100 in accordance with the embodiment with reference to FIGS. 4 and 5. FIG. 4 is a view illustrating an example of processing for controlling a motor in an image forming apparatus in accordance with the embodiment when an abnormality occurs after stop of the motor. FIG. 5 is a view illustrating an example of processing for controlling the motor in an image forming apparatus in accordance with the embodiment when an abnormality occurs during rotation of the motor. In FIGS. 4 and 5, the vertical axis represents the rotation speed of the motors 201, and the horizontal axis represents time.

In the embodiment, the motor controller 303 controls the motors 201 using an operation request flag, a mask flag, a physical state flag, and the stop-time rotation detection state information. The operation request flag represents whether the received operation request indicates rotation of the motors 201. When an operation request indicates rotation of the motors 201, the operation request flag represents “drive”, and when an operation request indicates stop of the motors 201, the operation request flag represents “stop”. The mask flag represents whether a mask period that is an example of an elapsed time after reception of an operation request indicating stop of the motors 201 exceeds a first threshold (an example of a first predetermined time) that is an upper limit of a time required for stopping rotation of the motors 201 (braking time). When the mask period does not exceed the first threshold, the mask flag represents “on”, and when the mask period exceeds the first threshold, the mask flag represents “off”. The physical state flag represents whether the motors 201 are rotating or stopped. When the stop-time rotation detection state information indicates “1” (in other words, when the motors 201 are rotating), the physical state flag represents “rotation”, and when the stop-time rotation detection state information indicates “0” (in other words, when the motors 201 are stopped), the physical state flag represents “stop”.

When the stop-time rotation detection state information represents “1” (in other words, when the physical state flag represents “rotation”) and the mask flag represents “off”, the motor controller 303 determines that rotation of the motors 201 is detected despite reception of an operation request indicating stop of the motors 201 (in the embodiment, a stop-time rotation determination result: “rotation”). When the stop-time rotation determination result represents “rotation”, the motor controller 303 outputs a brake signal indicating stop of rotation of the motors 201: “brake-on” to the motor driver circuit 202, and forcibly stops the rotation of the motors 201. By contrast, when the stop-time rotation detection state information represents “0” (in other words, when the physical state flag represents “stop”) or the mask flag represents “on”, the motor controller 303 determines that rotation of the motors 201 is not detected in the case of reception of an operation request indicating stop of the motors 201 (in the embodiment, a stop-time rotation determination result: “none”). In this case, the motor controller 303 does not output a brake signal: “brake-on”. When a state of the stop-time rotation determination result: “rotation” is continued for a predetermined time (hereinafter, referred to as a stop-time rotation detection period), the motor controller 303 determines that an abnormality has occurred in the stop of the motors 201 (in the embodiment, stop-time rotation abnormality determination result: “abnormality”). When the stop-time rotation abnormality determination result represents “abnormality”, the motor controller 303 may output a brake signal: “brake-on” to the motor driver circuit 202, and forcibly stop the rotation of the motors 201.

The following describes processing for controlling the motors 201 when an abnormality occurs after the stop of the motors 201 with reference to FIG. 4. When the image forming apparatus 100 is powered on (Step S401), the motor controller 303 controls the driver signal generator 307 to output a PWM signal having a duty ratio of 0% and a brake signal indicating “brake-off” to the motor driver circuit 202. In this manner, the motors 201 are in a stopped state. In addition, the motor controller 303 defines an operation request flag as “stop” until the operation request receiver 302 receives an operation request indicating rotation of the motors 201. The motor controller 303 also defines a mask flag as “off”. The motor controller 303 also defines a physical state flag as “stop”. The motor controller 303 defines a stop-time rotation determination result as “none”. The motor controller 303 defines a stop-time rotation abnormality determination result as “none”.

When the operation request receiver 302 receives an operation request indicating rotation of the motors 201 (Step S402), the motor controller 303 controls the driver signal generator 307 to output a low-active PWM signal having a predetermined duty ratio and a brake signal indicating “brake-off” to the motor driver circuit 202. In this manner, the motors 201 rotate at the rotation speed of a target rotation speed included in the received operation request. In the embodiment, when the motors 201 are rotated, the driver signal generator 307 outputs a low-active PWM signal, but this is not limiting. The driver signal generator 307 may output a high-active PWM signal. In addition, the motor controller 303 defines an operation request flag as “drive”, keeps a mask flag as “off”, defines a physical state flag as “rotation”, and defines both a stop-time rotation determination result and a stop-time rotation abnormality determination result as “none”.

Subsequently, when the operation request receiver 302 receives an operation request indicating stop of the motors 201 (Step S403), the motor controller 303 controls the driver signal generator 307 to output a PWM signal having a duty ratio of 0% and a brake signal indicating “brake-off” to the motor driver circuit 202. In this manner, the motors 201 perform excitation off stop for stopping the motors 201 while gradually decreasing the rotation speed of the motors 201. In addition, the motor controller 303 defines an operation request flag as “stop”, defines a mask flag as “on” until a mask period reaches the first threshold, defines a physical state flag as “stop” after the motors 201 stop, and defines both a stop-time rotation determination result and a stop-time rotation abnormality determination result as “none”.

When an operation request flag is defined as “stop”, a mask flag represents “off” and a physical state flag represents “stop”. However, when occurrence of ground fault and the like affects the motors 201 after stop of the motors 201 and the motors 201 start rotating due to malfunction, a physical state flag represents “rotation” even though an operation request flag is defined as “stop”. The motor controller 303 detects malfunction of the motors 201 due to an effect of occurrence of ground fault and the like (Step S404), and determines a stop-time rotation determination result as “rotation”. For example, an effect of occurrence of ground fault and the like causes the driver signal generator 307 to output a PWM signal having a duty ratio of 100%, and malfunction of rotation of the motors 201 occurs. In this case, the motor controller 303 controls the driver signal generator 307 to output a brake signal indicating “brake-on” on the motors 201 to the motor driver circuit 202. In this manner, rotation of the motors 201 is forcibly stopped (Step S405).

In other words, when ground fault and the like occur after stop of the motors 201 and the motors 201 malfunction, if a mask time after reception of an operation request indicating stop of the motors 201 reaches the first threshold (an example of a first predetermined time) and the stop-time rotation detector 305 detects rotation of the motors 201, the motor controller 303 stops the motors 201. In this manner, when an effect of occurrence of ground fault and the like after stop of the motors 201 cause the motors 201 to malfunction, the motors 201 can be stopped even though a signal indicating power-off of the motors 201 is input. Thus, when a power-off terminal is deleted from the motor control board 204, an increase in circuit scale can be prevented, and malfunction of the motors 201 in a state in which stop of the motors 201 is indicated can be prevented.

In the embodiment, after a mask period reaches the first threshold, when a stop-time rotation detection period that is a time of a stop-time rotation determination result representing “rotation” (in other words, a time when the stop-time rotation detector 305 successively detects rotation of the motors 201) reaches a second threshold (an example of a second predetermined time) due to an effect of occurrence of ground fault and the like (Step S404), the motor controller 303 may stop the motors 201. In this manner, when the stop-time rotation detector 305 erroneously detects rotation of the motors 201, processing for stopping the motors 201 can be prevented from being performed.

When the stop-time rotation detector 305 detects rotation of the motors 201 a predetermined number of times or more and continuously after due to an effect of occurrence of ground fault and the like (Step S404) after a mask period reaches the first threshold, the motor controller 303 may stop the motors 201. In this manner, when the stop-time rotation detector 305 erroneously detects rotation of the motors 201, processing for stopping the motors 201 can be prevented from being performed.

The following describes processing for controlling the motors 201 when an abnormality occurs during rotation of the motors 201 with reference to FIG. 5. Processing for powering on the image forming apparatus 100 (Step S401) and receiving an operation request indicating rotation of the motors 201 (Step S402) so as to rotate the motors 201 is the same as that in FIG. 4. After that, when ground fault and the like occur during rotation of the motors 201 (Step S501), the driver signal generator 307 keeps outputting a PWM signal having a duty ratio of 100%. When the operation request receiver 302 receives an operation request indicating stop of the motors 201 (Step S502), the motor controller 303 defines an operation request flag as “stop”. In this case, a physical state flag is defined as “rotation” despite the operation request flag defined as “stop”. Thus, the motor controller 303 detects malfunction of the motors 201, and determines a stop-time rotation determination result as “rotation”. Also, in this case, the motor controller 303 controls the driver signal generator 307 to output a brake signal indicating “brake-on” on the motors 201 to the motor driver circuit 202. In this manner, rotation of the motors 201 is forcibly stopped (Step S503).

In other words, when occurrence of ground fault and the like causes the motors 201 to malfunction during rotation of the motors 201, if the stop-time rotation detector 305 detects rotation of the motors 201 after a mask period from reception of an operation request indicating stop of the motors 201 reaches the first threshold, the motor controller 303 stops the motors 201. In this manner, when an effect of occurrence of ground fault and the like causes the motors 201 to malfunction during rotation of the motors 201, the motors 201 can be stopped even though a signal indicating power-off of the motors 201 is input. Thus, when a power-off terminal is deleted from the motor control board 204, an increase in circuit scale can be prevented, and malfunction of the motors 201 in a state in which stop of the motors 201 is indicated can be prevented.

When ground fault and the like occur during rotation of the motors 201, if a stop-time rotation detection period reaches the second threshold due to an effect of occurrence of ground fault and the like (Step S501) after a mask period reaches the first threshold, the motor controller 303 may stop the motors 201. In this manner, when the stop-time rotation detector 305 erroneously detects rotation of the motors 201, processing for stopping the motors 201 can be prevented from being performed.

When the stop-time rotation detector 305 detects rotation of the motors 201 a predetermined number of times or more and continuously after due to an effect of occurrence of ground fault and the like (Step S501) after a mask period reaches the first threshold, the motor controller 303 may stop the motors 201. In this manner, when the stop-time rotation detector 305 erroneously detects rotation of the motors 201, processing for stopping the motors 201 can be prevented from being performed.

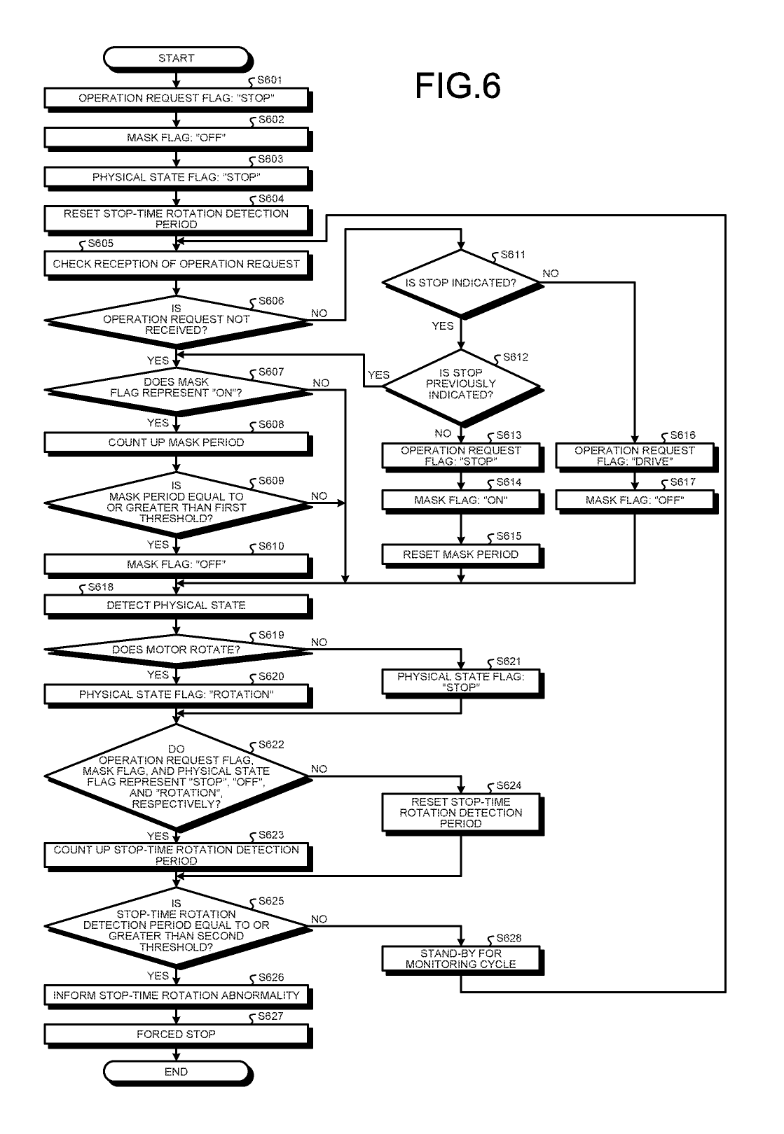

The following describes a flow of processing for controlling the motors 201 executed by the motor control device 20 with reference to FIG. 6. FIG. 6 is a flowchart illustrating an example of the flow of processing for controlling the motor executed by the motor control device in the image forming apparatus in accordance with the embodiment.

When the image forming apparatus 100 is powered on, the motor controller 303 defines an operation request flag as “stop” (Step S601) until the operation request receiver 302 receives an operation request indicating rotation of the motors 201. The motor controller 303 also defines a mask flag as “off” (Step S602) and a physical state flag as “stop” (Step S603). In addition, the motor controller 303 resets a stop-time rotation detection period (Step S604).

The motor controller 303 check whether the operation request receiver 302 does not receive an operation request per predetermined monitoring cycle (Step S605). When the operation request receiver 302 does not receive an operation request (Yes at Step S606), the motor controller 303 determines whether a mask flag represents “on” (Step S607). When a mask flag represents “on” (Yes at Step S607), the motor controller 303 counts up a mask period (Step S608). Subsequently, the motor controller 303 determines whether a mask period after count-up is equal to or greater than the first threshold (Step S609). When a mask period after count-up is equal to or greater than the first threshold (Yes at Step S609), the motor controller 303 defines a mask flag as “off” (Step S610). By contrast, when a mask flag represents “off” (No at Step S607) or when a mask period is shorter than the first threshold (No at Step S609), the process proceeds to processing at Step S618. The motor controller 303 may change the first threshold depending on the rotation speed of the motors 201 when an operation request indicating stop of the motors 201 is received (in other words, the rotation speed of the motors 201 when a mask flag represents “on”). For example, the motor controller 303 increases the first threshold as the rotation speed of the motors 201 is accelerated. In this manner, the first threshold is set in consideration of a braking time of the motors 201. Thus, after a mask period reaches the first threshold, rotation of the motors 201 is erroneously detected before a braking time of the motors 201 elapses so as to prevent the motors 201 from being stopped.

When receiving an operation request (No at Step S606), the motor controller 303 determines whether the received operation request indicates stop of the motors 201 (Step S611). When the received operation request indicates stop of the motors 201 (Yes at Step S611), the motor controller 303 determines whether a previously received operation request also indicates stop of the motors 201 (Step S612). When the previously received operation request also indicates stop of the motors 201 (Yes at Step S612), the process proceeds to processing at Step S607. In other words, when receiving a new operation request indicating stop of the motors 201 before a mask period reaches the first threshold, the motor controller 303 does not reset the mask period. In this manner, when a new operation request is received during a mask period, the mask period can be prevented from being extended. By contrast, when the previously received operation request does not indicate stop of the motors 201 (No at Step S612), the motor controller 303 defines an operation request flag as “stop” (Step S613), and defines a mask flag as “on” (Step S614). In addition, the motor controller 303 stops the motors 201. Furthermore, the motor controller 303 resets a mask period, and starts counting up the mask period (Step S615). Subsequently, the process proceeds to processing at Step S618.

When the received operation request indicates rotation of the motors 201 (No at Step S611), the motor controller 303 defines an operation request flag as “drive” (Step S616), and defines a mask flag as “off” (Step S617). In addition, the motor controller 303 adjusts the rotation speed of the motors 201 to a target rotation speed indicated by the received operation request. Subsequently, the process proceeds to processing at Step S618.

The motor controller 303 detects a result of the rotation speed of the motors 201 detected by the rotation speed detector 304 as a physical state of the motors 201 at Step S618. The motor controller 303 determines whether the motors 201 are rotating on the basis of the detected physical state (Step S619). When the motors 201 are rotating (Yes at Step S619), the motor controller 303 defines a physical state flag as “rotation” (Step S620). By contrast, when the motors 201 are stopped (No at Step S619), the motor controller 303 defines a physical state flag as “stop” (Step S621).

Subsequently, the motor controller 303 determines whether an operation request flag represents “stop”, a mask flag represents “off”, and a physical state flag represents “rotation” (Step S622). When an operation request flag, a mask flag, and a physical state flag represent “stop”, “off”, and “rotation”, respectively (Yes at Step S622), the motor controller 303 determines that the motors 201 are possibly rotating due to an effect of occurrence of ground fault and the like, and counts up a stop-time rotation detection period (Step S623). By contrast, when an operation request flag, a mask flag, and a physical state flag do not represent “stop”, “off”, and “rotation”, respectively (No at Step S622), the motor controller 303 determines that the motors 201 are not rotating due to malfunction, and resets a stop-time rotation detection period (Step S624).

Subsequently, the motor controller 303 determines whether a stop-time rotation detection period is equal to or greater than the second threshold (Step S625). When a stop-time rotation detection period is equal to or greater than the second threshold (Yes at Step S625), the motor controller 303 determines that the motors 201 are rotating due to an effect of occurrence of ground fault and the like, and informs the state notifier 306 of stop-time rotation abnormality indicating an abnormality in rotation of the motors 201 (Step S626). The motor controller 303 controls the driver signal generator 307 to forcibly stop the motors 201 (Step S627).

By contrast, when a stop-time rotation detection period does not reach the second threshold (No at Step S625), the motor controller 303 stands by for a predetermined monitoring cycle (Step S628), and the process returns to processing at Step S605.

In this manner, when a power-off terminal is deleted from the motor control board 204, the image forming apparatus 100 according to the first embodiment can prevent an increase in circuit scale, and prevent malfunction of the motors 201 in a state in which stop of the motors 201 is indicated.

In the embodiment, when an operation request received in the period from power-on of the motors 201 until the lapse of a predetermined time indicates stop of the motors 201, the stop-time rotation detector 305 detects rotation of the motors 201 before a mask period reaches the first threshold. Immediately after the motors 201 are powered on, it is assumed that the rotation speed of the motors 201 is possibly slow and a braking time of the motors 201 becomes short. Thus, immediately after the motors 201 are powered on, if an operation request indicates stop of the motors 201, malfunction of the motors 201 can be more appropriately prevented by immediately stopping the motors 201.

### Second Embodiment

The embodiment is an example where a host apparatus transmits, when transmitting an operation request indicating rotation of motors and detecting an abnormality in rotation of at least one of the motors, an operation request indicating stop of a plurality of motors to a motor control board. Hereinafter, the same configuration as that of the first embodiment is omitted.

In the embodiment, when detecting an abnormality in rotation of at least one motor 201 in a state in which an operation request received by the operation request receiver 302 indicates rotation of the motors 201 so as to rotate the motors 201, the motor controller 303 informs the host apparatus 210 of an operation state indicating an abnormality at the time of driving through the state notifier 306. When an operation state informed by the motor drive apparatus 200 indicates an abnormality at the time of driving in a state in which an operation request indicating rotation of the motors 201 is transmitted to the motor drive apparatus 200 so as to drive the motors 201, the host apparatus controller 311 of the host apparatus 210 transmits an operation request indicating stop of the plurality of motors 201 to the motor control board 204 through the operation request transmitter 310. When the operation request receiver 302 receives the operation request indicating stop of the motors 201, the motor controller 303 stops rotation of all of the motors 201. In this manner, when an operation request indicating rotation of the motors 201 is received and an abnormality occurs in a part of the motors 201, all of the motors 201 stop and conveyance of the recording medium P is stopped. This processing can prevent a paper jam of the recording medium P due to malfunction of a part of the motors 201 from being generated. In the embodiment, when detecting an abnormality in rotation of the motors 201 in a state in which an operation request indicating rotation of the motors 201 is received so as to rotate the motors 201, the motor controller 303 stands by for reception of an operation request indicating stop of the motors 201 from the host apparatus 210 and stops rotation of the motors 201, but this is not limiting. The motor controller 303 may stop rotation of at least the motor 201 in which an abnormality is detected without standing by for reception of an operation request indicating rotation of the motors 201 from the host apparatus 210.

When an abnormality in rotation of the motors 201 is detected in a state in which an operation request indicating rotation of the motors 201 is transmitted so as to rotate the motors 201, the motor controller 303 can stop a heater included in the fixing apparatus 136 and the like from heating the recording medium P (an example of a medium) and the like conveyed by rotation of the motors 201. This processing can stop conveyance of the recording medium P when a heater included in the fixing apparatus 136 and the like heats the recording medium P, and can prevent occurrence of an abnormality in operation of the whole image forming apparatus 100 due to heating of a specific part of the recording medium P.

When an abnormality in rotation of the motors 201 is detected in a state in which an operation request indicating rotation of the motors 201 is transmitted so as to rotate the motors 201, the motor controller 303 prohibits application of bias related to image forming (for example, application of bias to the developing devices 121k, 121y, 121m, and 121c and the fixing apparatus 136. In this manner, even though rotation of the motors 201 is stopped and an image is not formed on the recording medium P, bias related to image forming can be prevented from being continuously applied so as to reduce power consumption due to application of bias related to image forming.

In the embodiment, the motor drive apparatus 200 drives various kinds of conveyance mechanisms included in the image forming apparatus 100, but this is not limiting if an apparatus drives a conveyance mechanism such as a conveyance roller in a conveyance apparatus that conveys a medium such as prepregs and plastic sheets, and paper money.

A computer program executed by the image forming apparatus 100 according to the embodiments is preliminarily built into a ROM and the like so as to be provided. The computer program executed by the image forming apparatus 100 according to the embodiments is a file in an installable format or in an executable format, and may be recorded and provided in computer-readable storage media such as a compact disc read only memory (CD-ROM), a flexible disk (FD), a compact disc recordable (CD-R), and a digital versatile disc (DVD).

In addition, the computer program executed by the image forming apparatus 100 according to the embodiments may be stored in a computer connected to networks such as the Internet and be downloaded via a network so as to be provided. The computer program executed by the image forming apparatus 100 according to the embodiments may be provided or distributed via networks such as the Internet.

The computer program executed by the image forming apparatus 100 according to the embodiments has a module configuration that includes the above-mentioned units (the operation request receiver 302, the motor controller 303, the rotation speed detector 304, the stop-time rotation detector 305, and the state notifier 306). As actual hardware, a CPU loads the computer program from the ROM and executes the computer program so as to load the above-mentioned units on a main storage unit and generate the operation request receiver 302, the motor controller 303, the rotation speed detector 304, the stop-time rotation detector 305, and the state notifier 306 on the main storage unit.

The embodiments describe an example where the image forming apparatus according to the present invention is applied to a multifunction peripheral having at least two functions out of copier, printer, scanner, and facsimile functions, but the image forming apparatus according to the present invention can be applied to any image forming apparatus such as a copier, a printer, a scanner, and a facsimile apparatus.

According to the present invention, malfunction of a motor can be prevented in a state in which stop of the motor is indicated and an increase in circuit scale can be prevented.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. A motor control device comprising:
a controller configured to control, when receiving an operation request indicating rotation or stop of a motor, rotation of the motor based on the operation request; and
a detector configured to detect whether the motor is rotating, wherein
the controller stops the motor when the detector detects rotation of the motor after an elapsed time from reception of the operation request indicating stop of the motor reaches a first threshold.

2. The motor control device according to claim 1, wherein the controller stops the motor when a time in which the detector continuously detects rotation of the motor reaches a second threshold after the elapsed time reaches the first threshold.

3. The motor control device according to claim 1, wherein the controller stops the motor when the detector detects rotation of the motor a predetermined number of times or more and continuously after the elapsed time reaches the first threshold.

4. The motor control device according to claim 1, wherein the detector detects, when the operation request received in a period from power-on of the motor until a lapse of a predetermined time indicates stop of the motor, rotation of the motor before the elapsed time reaches the first threshold.

5. The motor control device according to claim 1, wherein the controller does not reset the elapsed time when receiving a new operation request indicating stop of the motor before the elapsed time reaches the first threshold.

6. The motor control device according to claim 1, wherein the detector changes the first threshold depending on a rotation speed of the motor.

7. The motor control device according to claim 1, wherein the controller stops supplying power to a brake or the motor so as to stop the motor.

8. A motor control system comprising:
the motor control device according to claim 1; and
the motor.

9. An image forming apparatus comprising the motor control system according to claim 8.

10. The image forming apparatus according to claim 9, further comprising:
a plurality of the motors; and
a host controller configured to transmit the operation request to the motor control device, wherein
the host controller transmits, when the detector detects an abnormality in rotation of at least one of the motors in a state in which the operation request indicating rotation of the motors is transmitted to the motor control device so as to rotate the motors, the operation request indicating stop of the motors to the motor control device.

11. The image forming apparatus according to claim 10, further comprising a heater configured to heat a medium conveyed by rotation of the motors, wherein
the host controller stops, when the detector detects an abnormality in rotation of at least one of the motor in a state in which the operation request indicating rotation of the motors is transmitted to the motor control device so as to rotate the motors, the heater from heating the recording medium.

12. The image forming apparatus according to claim 10, wherein the host controller prohibits, when the detector detects an abnormality in rotation of at least one of the motors in a state in which the operation request indicating rotation of the motors is transmitted to the motor control device so as to rotate the motors, application of bias related to image forming.

13. A conveyance apparatus comprising the motor control device according to claim 8.

14. The conveyance apparatus according to claim 13, further comprising:
a plurality of the motors; and
the host controller configured to transmit the operation request to the motor control device, wherein
the host controller transmits, when the operation request indicating rotation of the motors is transmitted to the motor control device and the detector detects an abnormality in rotation of at least one of the motors, the operation request indicating stop of the motors to the motor control device.

15. A motor control method comprising:
controlling, when receiving an operation request indicating rotation or stop of a motor, rotation of the motor based on the operation request;
detecting whether the motor is rotating; and
stopping the motor when the rotation of the motor is detected after an elapsed time from reception of the operation request indicating stop of the motor reaches a first threshold.

16. The motor control method according to claim 15, wherein the stopping includes stopping the motor when a time in which the rotation of the motor is continuously detected reaches a second threshold after the elapsed time reaches the first threshold.

17. The motor control method according to claim 15, wherein the stopping includes stopping the motor when the rotation of the motor is detected a predetermined number of times or more and continuously after the elapsed time reaches the first threshold.

18. The motor control method according to claim 15, wherein the detecting includes detecting, when the operation request received in a period from power-on of the motor until a lapse of a predetermined time indicates stop of the motor, rotation of the motor before the elapsed time reaches the first threshold.

19. The motor control method according to claim 15, wherein the controlling includes not resetting the elapsed time when receiving a new operation request indicating stop of the motor before the elapsed time reaches the first threshold.

20. The motor control method according to claim 15, further comprising changing the first threshold depending on a rotation speed of the motor at the detecting.
